(19) United States
(12) Patent Application Publication
(10) Pub. No.: US 2025/0279449 A1
(43) Pub. Date: Sep. 4, 2025

(54) COOLING SYSTEM FOR FUEL CELL

(71) Applicant: TOYOTA JIDOSHA KABUSHIKI KAISHA, Toyota-shi (JP)

(72) Inventors: Atsuo IIO, Nagoya-shi (JP); Kazuo YAMAMOTO, Toyota-shi (JP); Keisuke YOKOTA, Nisshin-shi (JP); Morio SHINODA, Anjo-shi (JP)

(73) Assignee: TOYOTA JIDOSHA KABUSHIKI KAISHA, Toyota-shi (JP)

(21) Appl. No.: 19/026,588

(22) Filed: Jan. 17, 2025

(30) Foreign Application Priority Data
Feb. 29, 2024 (JP) 2024-029908

(51) Int. Cl. H01M 8/04664; H01M 8/04007; H01M 8/04029; H01M 8/0432; H01M 8/04746

(52) U.S. Cl. CPC H01M 8/04686; H01M 8/04029; H01M 8/04074; H01M 8/04358; H01M 8/04768

(57) ABSTRACT

A cooling system for a fuel cell that cools a fuel cell stack and an intercooler includes a radiator, a stack cooling circuit, an intercooler cooling circuit, a bypass channel, a flow regulating valve that regulates a flow diversion ratio to the bypass channel, a first temperature sensor, a second temperature sensor, and a control device that performs an abnormality monitoring process of monitoring the cooling system for an abnormality. The abnormality monitoring process includes a first determination process of determining that there is an abnormality when the flow diversion ratio of the flow regulating valve is 100 percent and the difference between the detected value by the first temperature sensor and the detected value by the second temperature sensor is equal to or greater than the first predetermined value.

### CROSS-REFERENCE TO RELATED APPLICATION

This application claims priority to Japanese Patent Application No. 2024-029908 filed on Feb. 29, 2024, incorporated herein by reference in its entirety.

### BACKGROUND

### 1. Technical Field

The technique disclosed in the present specification relates to cooling systems for fuel cells.

### 2. Description of Related Art

Japanese Unexamined Patent Application Publication No. 2018-106901 (JP 2018-106901 A) describes a cooling system for a fuel cell that cools a fuel cell stack and an intercooler. The cooling system includes a radiator, a stack cooling circuit, an intercooler cooling circuit, and a bypass channel that bypasses the radiator. The cooling system includes a flow regulating valve that regulates the flow diversion ratio to the bypass channel, a temperature sensor that detects the temperature of an oxidizing gas after passing through the intercooler, and a control device. The control device estimates the temperature of the oxidizing gas after passing through the intercooler, based on the temperature of the cooling medium after passing through the fuel cell stack, the temperature of the cooling medium after passing through the radiator, the pressure of the oxidizing gas after passing through the intercooler, etc. When the difference between the estimated value and the detected value from the temperature sensor is equal to or greater than a predetermined value, the control device determines that the cooling system is abnormal.

### SUMMARY

In the above cooling system, the temperature of the oxidizing gas after passing through the intercooler is estimated based on the detected values from a plurality of sensors. Therefore, if an abnormality occurs in any one of the sensors, the estimated value may have an error, so that an abnormality of the cooling system may not be correctly determined.

In view of the above circumstances, the present specification provides a technique for monitoring a cooling system for an abnormality by a relatively simple configuration.

The technique disclosed in the present specification is embodied in a cooling system for a fuel cell that cools a fuel cell stack and an intercooler that cools an oxidizing gas to be supplied to the fuel cell stack.

According to a first aspect, the cooling system includes: a radiator; and
a stack cooling circuit including a first cooling medium outgoing channel that sends a cooling medium from the radiator to the fuel cell stack, and a first cooling medium return channel that returns the cooling medium from the fuel cell stack to the radiator;
an intercooler cooling circuit including a second cooling medium outgoing channel that branches off from the first cooling medium outgoing channel and that sends the cooling medium to the intercooler, and a second cooling medium return channel that merges from the intercooler into the first cooling medium return channel and that returns the cooling medium;
a bypass channel that branches off from the first cooling medium return channel to bypass the radiator and that sends the cooling medium to the first cooling medium outgoing channel;
a flow regulating valve that is located at a branch point where the bypass channel branches off from the first cooling medium return channel and that regulates a flow diversion ratio to the bypass channel;
a first temperature sensor that is located in the first cooling medium return channel and that detects a temperature of the cooling medium after passing through the fuel cell stack;
a second temperature sensor that detects a temperature of the oxidizing gas after passing through the intercooler; and
a control device that performs an abnormality monitoring process of monitoring the cooling system for an abnormality.
   The abnormality monitoring process includes a first determination process of determining that there is an abnormality when the flow diversion ratio of the flow regulating valve is 100 percent and a difference between a detected value from the first temperature sensor and a detected value from the second temperature sensor is equal to or greater than a first predetermined value.

In the above configuration, the cooling medium after passing through the fuel cell stack is normally returned to the radiator through the first cooling medium return channel and cooled in the radiator. However, when the flow diversion ratio of the flow regulating valve is 100 percent, the cooling medium after passing through the fuel cell stack is returned to the first cooling medium outgoing channel without passing through the radiator. Part of the cooling medium returned to the first cooling medium outgoing channel is sent to the intercooler through the second cooling medium outgoing channel, exchanges heat with the oxidizing gas, and then merges into the first cooling medium return channel. The heat capacity of the oxidizing gas that is a gas is sufficiently smaller than the heat capacity of the cooling medium that is a liquid. Therefore, there is no substantial change in temperature of the cooling medium before and after passing through the intercooler. Accordingly, three temperatures, namely the temperature of the cooling medium before passing through the intercooler, the temperature of the cooling medium after passing through the intercooler, and the temperature of the oxidizing gas after passing through the intercooler, are always approximate to each other.

Based on the above, when the flow diversion ratio of the flow regulating valve is 100 percent, the temperature of the cooling medium after passing through the fuel cell stack and the temperature of the oxidizing gas after passing through the intercooler are approximate to each other. That is, the detected value from the first temperature sensor and the detected value from the second temperature sensor should be approximate to each other. Therefore, the cooling system according to the present technique is configured to determine that there is an abnormality when the difference between the detected value from the first temperature sensor and the detected value from the second temperature sensor is equal to or greater than the first predetermined value. With such a configuration, it is possible to easily detect an abnormality in the cooling system by merely comparing the detected values from the two temperature sensors. The first predetermined value as used herein can be set to an appropriate value as desired in consideration of possible natural heat dissipation of the cooling medium, possible measurement errors of each temperature sensor, etc.

On the other hand, when the flow diversion ratio to the bypass channel is zero percent, the cooling medium after passing through the radiator is sent to the intercooler through the second cooling medium outgoing channel without being mixed with the cooling medium from the bypass channel. Therefore, the temperature of the cooling medium after passing through the radiator is approximate to the temperature of the cooling medium before passing through the intercooler, and is also approximate to the temperature of the oxidizing gas after passing through the intercooler.

In view of the above, according to a second aspect, in the first aspect, the cooling system may further include a third temperature sensor that is located in the first cooling medium outgoing channel and that detects a temperature of the cooling medium after passing through the radiator.

In this case, the abnormality monitoring process may include a second determination process of determining that there is an abnormality when the flow diversion ratio of the flow regulating valve is zero percent and a difference between a detected value from the third temperature sensor and the detected value from the second temperature sensor is equal to or greater than a second predetermined value. With such a configuration as well, it is possible to easily detect an abnormality in the cooling system by merely comparing the detected values from the two temperature sensors.

According to a third aspect, in the second aspect, the abnormality monitoring process may further include a first identification process of, when determination is made in the first determination process that there is an abnormality, identifying an abnormal part by changing the flow diversion ratio of the flow regulating valve to zero percent and then performing the second determination process.

In this case, in the first identification process, when determination is also made in the second determination process that there is an abnormality, a part related to the second temperature sensor may be identified as the abnormal part, and when determination is made in the second determination process that there is no abnormality, a part related to the first temperature sensor may be identified as the abnormal part. With such a configuration, it is possible to identify an abnormal part in the cooling system by a relatively simple configuration.

According to a fourth aspect, in the second or third aspect, the abnormality monitoring process may further include a second identification process of, when determination is made in the second determination process that there is an abnormality, identifying an abnormal part by changing the flow diversion ratio of the flow regulating valve to 100 percent and then performing the first determination process.

In this case, in the second identification process, when determination is also made in the first determination process that there is an abnormality, a part related to the second temperature sensor may be identified as the abnormal part, and when determination is made in the first determination process that there is no abnormality, a part related to the third temperature sensor may be identified as the abnormal part. With such a configuration, it is possible to identify an abnormal part in the cooling system by a relatively simple configuration.

In the above cooling system, part of the cooling medium in the first cooling medium outgoing channel is sent to the intercooler via the second cooling medium outgoing channel regardless of the opening degree of the flow regulating valve. In this case, the temperature of the cooling medium before passing through the fuel cell stack is approximate to the temperature of the cooling medium before passing through the intercooler. As described above, the temperature of the cooling medium before passing through the intercooler is approximate to the temperature of the oxidizing gas after passing through the intercooler. Based on the above relationship, the temperature of the cooling medium before passing through the fuel cell stack is approximate to the temperature of the oxidizing gas after passing through the intercooler, regardless of the opening degree of the flow regulating valve.

In view of the above, according to a fifth aspect, in any one of the first to fourth aspects, the cooling system may further include a fourth temperature sensor that is located in the first cooling medium outgoing channel and that detects a temperature of the cooling medium before passing through the fuel cell stack.

In this case, the abnormality monitoring process may include a third determination process of determining that there is an abnormality when a difference between a detected value from the fourth temperature sensor and the detected value from the second temperature sensor is equal to or greater than a third predetermined value regardless of the flow diversion ratio of the flow regulating valve. With such a configuration, it is possible to easily detect an abnormality in the cooling system by merely comparing the detected values from the two temperature sensors.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of a cooling system 10 of an embodiment and a fuel cell system 100 in which the cooling system is employed;

FIG. 2 is a flowchart showing an abnormality monitoring process that is performed by the control device 32;

FIG. 3 is a flow chart showing a first identification process that is performed by the control device 32; and

FIG. 4 is a flowchart illustrating a second identification process that is performed by the control device 32.

### DETAILED DESCRIPTION OF EMBODIMENTS

Referring to the drawings, a cooling system 10 of the present embodiment and a fuel cell system 100 in which the cooling system is employed will be described. The cooling system 10 is a system that cools the fuel cell system 100 using a liquid cooling medium such as coolant. The specific configuration of the fuel cell system 100 is not particularly limited. The fuel cell system 100 may be employed as a power source for a moving object (for example, an automobile, a bus, a truck, a train, a ship, an airplane), or may be employed as a power source for stationary.

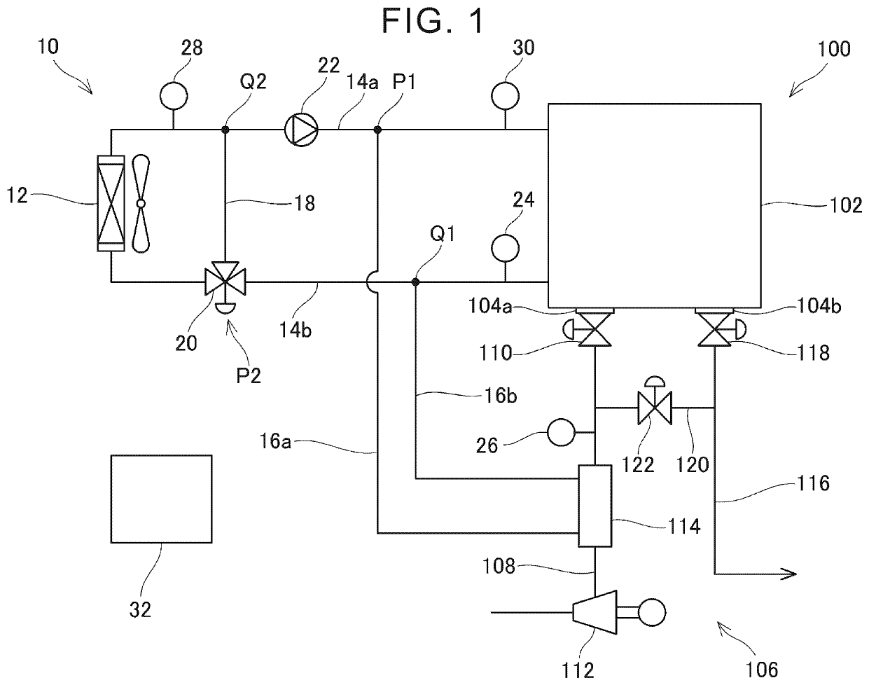

As shown in FIG. 1, the fuel cell system 100 includes a fuel cell stack 102. The fuel cell stack 102 has a structure in which a plurality of fuel cell cells is stacked. The fuel cell stack 102 includes an anode-side supply port (not shown), a cathode-side supply port 104a, an anode-side discharge port (not shown), and a cathode-side discharge port 104b. The anode-side supply port and the cathode-side supply port 104a of the fuel cell stacks 102 are connected to each of the plurality of fuel cell cells in the fuel cell stack 102. The fuel cell stacks 102 generate electric power by chemically reacting the fuel gas taken in from the anode-side supply port and the oxidizing gas taken in from the cathode-side supply port 104a in the plurality of fuel cell cells. The gas (i.e., off-gas) that has passed through the plurality of fuel cell stacks 102 is discharged to the outside from the anode-side discharge port and the cathode-side discharge port 104b.

As shown in FIG. 1, the fuel cell system 100 further includes an oxidizing gas supply unit 106. The oxidizing gas supply unit 106 is a unit for supplying air as an oxidizing gas to the fuel cell stack 102. The oxidizing gas supply unit 106 includes an oxidizing gas supply channel 108, an inlet valve 110, a compressor 112, an intercooler 114, an off-gas discharge channel 116, an outlet valve 118, a flow diverting channel 120, and a flow diverting valve 122.

The oxidizing gas supply channel 108 is a channel for supplying oxidizing gas (in this example, air) to the fuel cell stack 102. The oxidizing gas supply channel 108 is connected to the cathode-side supply port 104a of the fuel cell stack 102. The inlet valve 110 is provided in the cathode-side supply port 104a of the fuel cell stack 102. The compressor 112 is provided in the oxidizing gas supply channel 108, and compresses air taken from the outside and supplies the compressed air to the fuel cell stack 102. As an example, the compressor 112 is a turbo compressor. The intercooler 114 is provided on the outlet side of the compressor 112 in the oxidizing gas supply channel 108. The intercooler 114 cools the air by performing heat exchange between the air discharged from the compressor 112 and the cooling medium of the cooling system 10. As a result, the air discharged from the compressor 112 is cooled by the intercooler 114 and then supplied to the cathode-side supply port 104a of the fuel cell stack 102. Although not particularly limited, the oxidizing gas supply channel 108 may further include an air cleaner that removes foreign matters such as dust and dust from the air taken from the outside.

The off-gas discharge channel 116 is a channel for discharging the off-gas of the air from the fuel cell stack 102. The off-gas discharge channel 116 is connected to the cathode-side discharge port 104b of the fuel cell stack 102. The outlet valve 118 is provided at the cathode-side discharge port 104b in the fuel cell stack 102.

The flow diverting channel 120 connects the oxidizing gas supply channel 108 and the off-gas discharge channel 116 to each other. As an example, the flow diverting channel 120 in the present embodiment is connected to the off-gas discharge channel 116 on the outlet side of the intercooler 114. A flow diverting valve 122 is provided in the flow diverting channel 120. The inlet valve 110, the outlet valve 118, and the flow diverting valve 122 are control valves whose opening degree can be adjusted. The operation (opening degree) of the inlet valve 110, the outlet valve 118, and the flow diverting valve 122 is controlled by a control device (not shown). The control device can control the operation of the compressor 112, the inlet valve 110, the outlet valve 118, and the flow diverting valve 122 to adjust the supply pressure and the supply flow rate of the oxidizing gas supplied to each of the fuel cell stacks 102.

Although not shown, the fuel cell system 100 further includes a fuel gas supply unit. The fuel gas supply unit is a unit for supplying hydrogen gas as the fuel gas to the fuel cell stack 102.

Next, the cooling system 10 will be described. As shown in FIG. 1, the cooling system 10 circulates cooling medium to the fuel cell stack 102 and the intercooler 114. Thus, the fuel cell stack 102 and the air passing through the intercooler 114 are cooled. The cooling system 10 includes a radiator 12, a stack cooling circuit 14a, 14b, an intercooler cooling circuit 16a, 16b, a bypass channel 18, a three-way valve 20, a pump 22, a plurality of temperature sensors 24, 26, 28, 30, and a control device 32. The radiator 12 is a heat exchanger that exchanges heat between the cooling medium and the outside air, and is typically cooled by radiating the cooling medium.

The stack cooling circuit 14a, 14b includes a first cooling medium outgoing channel 14a and a first cooling medium return channel 14b. The first cooling medium outgoing channel 14a is provided between the radiator 12 and the fuel cell stack 102, and can transmit the cooling medium from the radiator 12 to the fuel cell stack 102. The first cooling medium return channel 14b is provided between the fuel cell stack 102 and the radiator 12, and can return the cooling medium from the fuel cell stack 102 to the radiator 12.

The intercooler cooling circuit 16a, 16b includes a second cooling medium outgoing channel 16a and a second cooling medium return channel 16b. The second cooling medium outgoing channel 16a is provided between the radiator 12 and the intercooler 114, and can transmit the cooling medium from the radiator 12 to the intercooler 114. The second cooling medium outgoing channel 16a branches off from the first cooling medium outgoing channel 14a at the first branch point P1. Thus, part of the cooling medium in the first cooling medium outgoing channel 14a is sent to the second cooling medium outgoing channel 16a at the first branch point P1. The second cooling medium return channel 16b is provided between the intercooler 114 and the radiator 12, and can return the cooling medium from the intercooler 114 to the radiator 12. The second cooling medium return channel 16b merges into the first cooling medium return channel 14b at the first merging point Q1. Thus, the cooling medium in the second cooling medium return channel 16b that has passed through the intercooler 114 merges into the cooling medium in the first cooling medium return channel 14b that has passed through the fuel cell stack 102 at the first merging point Q1.

The bypass channel 18 branches off from the first cooling medium return channel 14b at the second branch point P2 and merges with the first cooling medium outgoing channel 14a at the second merging point Q2. A three-way valve 20 is provided at a second branch point P2 where the bypass channel 18 branches off from the first cooling medium return channel 14b. The operation (opening degree) of the three-way valve 20 is controlled by the control device 32. The control device 32 can adjust the flow diversion ratio to the bypass channel 18 by adjusting the opening degree of the three-way valve 20. The flow diversion ratio to the bypass channel 18 refers to the ratio of the flow rate of the cooling medium flowing to the bypass channel 18 to the flow rate of the cooling medium passing through the second branch point P2 in the first cooling medium return channel 14b. The pump 22 is provided between the second merging point Q2 and the first branch point P1 in the first cooling medium outgoing channel 14a.

The plurality of temperature sensors 24, 26, 28, and 30 include a first temperature sensor 24, a second temperature sensor 26, a third temperature sensor 28, and a fourth temperature sensor 30. The first temperature sensor 24 is provided near the outlet of the fuel cell stack 102 in the first cooling medium return channel 14b, and detects the temperature of the cooling medium after passing through the fuel cell stack 102. The cooling medium absorbs heat from the fuel cell when passing through the plurality of fuel cells in the fuel cell stack 102. Therefore, the detected value S1 from the first temperature sensor 24, i.e., the temperature of the cooling medium after passing through the fuel cell stack 102, is approximate to the temperature of the fuel cell stack 102.

The control device 32 determines a target cooling temperature of the fuel cell stack 102. Then, the control device 32 controls the pump 22 based on the detected value S1 by the first temperature sensor 24 to adjust the flow rate of the cooling medium supplied to the fuel cell stack 102, thereby cooling the fuel cell stack 102 so that the temperature of the fuel cell stack 102 becomes the target cooling temperature.

The second temperature sensor 26 is provided on the outlet side of the intercooler 114 in the oxidizing gas supply channel 108, and detects the temperature of the air after passing through the intercooler 114. The third temperature sensor 28 is provided at the outlet of the radiator 12 in the first cooling medium outgoing channel 14a, and detects the temperature of the cooling medium after passing through the radiator 12. The fourth temperature sensor 30 is provided near the inlet of the fuel cell stack 102 in the first cooling medium outgoing channel 14a, and detects the temperature of the cooling medium before passing through the fuel cell stack 102. Detected values S1, S2, S3, S4 detected by the respective temperature sensors 24, 26, 28, 30 are obtained by the control device 32.

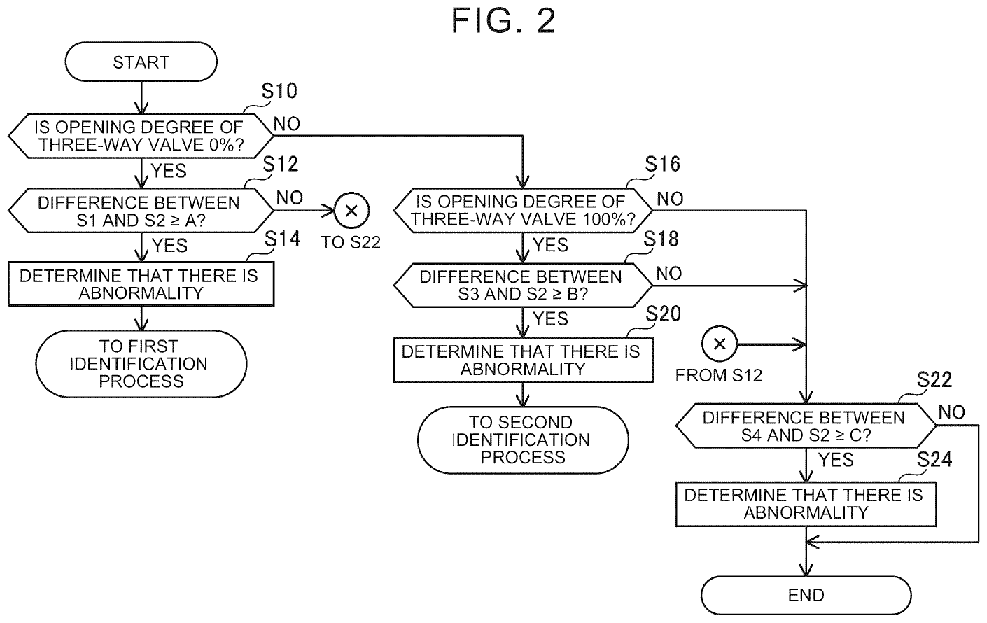

Next, an abnormality monitoring process that is performed by the control device 32 will be described with reference to FIGS. 2 to 4. The control device 32 can monitor the cooling system 10 for an abnormality by performing the abnormality monitoring process.

As shown in FIG. 2, the control device 32 determines whether the opening degree of the three-way valve 20 is zero percent (S10). As described above, the control device 32 controls the opening degree of the three-way valve 20 and monitors the opening degree of the three-way valve 20. When the opening degree of the three-way valve 20 is zero percent, the flow diversion ratio to the bypass channel 18 is 100 percent. Therefore, the cooling medium after passing through the fuel cell stack 102 is returned to the first cooling medium outgoing channel 14a without passing through the radiator 12. In the fuel cell system 100 of the present embodiment, the opening degree of the three-way valve 20 is set to zero percent when the fuel cell stack 102 is activated.

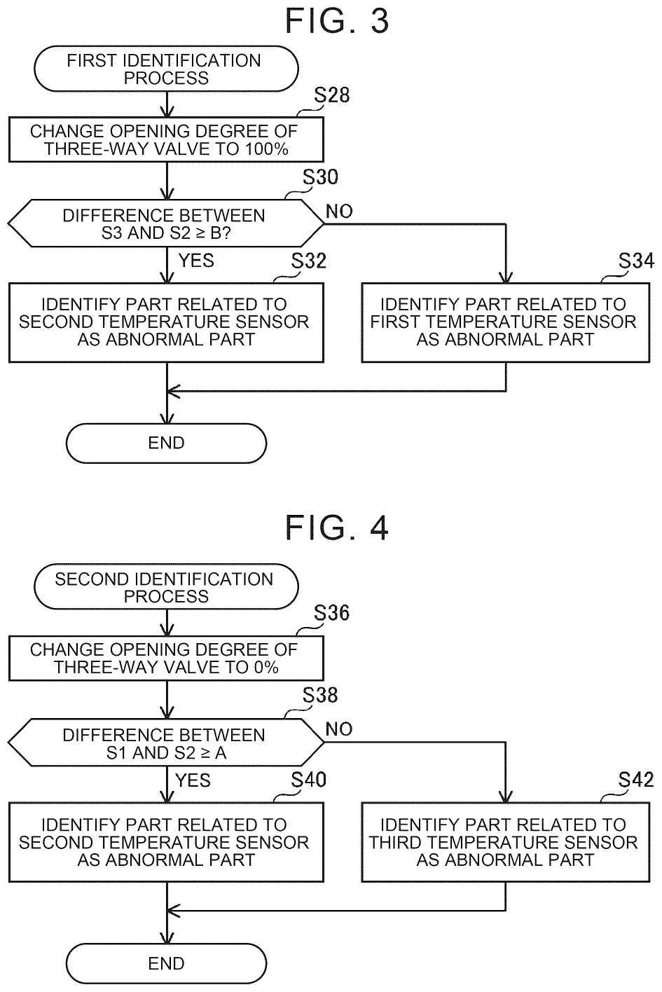

When S10 is YES, the control device 32 determines whether or not the difference between the detected value S1 from the first temperature sensor 24 and the detected value S2 from the second temperature sensor 26 is equal to or greater than the first predetermined value A (S12). Here, the difference between the detected value S1 from the first temperature sensor 24 and the detected value S2 from the second temperature sensor 26 means the absolute value of the difference between the two detected values S1, S2. When the opening degree of the three-way valve 20 is zero percent, part of the cooling medium after passing through the fuel cell stack 102 is sent to the intercooler 114 through the second cooling medium outgoing channel 16a, exchanges heat with the air, and then merges into the first cooling medium return channel 14b. Here, the heat capacity of the air which is a gas is sufficiently smaller than the heat capacity of the cooling medium which is a liquid. Therefore, no substantial temperature change occurs in the cooling medium before and after passing through the intercooler 114. Therefore, three temperatures, namely the temperature of the cooling medium before passing through the intercooler 114, the temperature of the cooling medium after passing through the intercooler 114, and the temperature of the air after passing through the intercooler 114, are always approximate to each other. The temperature of the cooling medium after passing through the fuel cell stack 102 is detected by the first temperature sensor 24, and the temperature of the air after passing through the intercooler 114 is detected by the second temperature sensor 26. The first predetermined value A can be determined in consideration of natural heat dissipation that may occur in the cooling medium, measurement errors that may occur in the temperature sensors 24 and 26, and the like. The first predetermined value A may be a constant value, or may be a variation value that is changed according to a specific condition. When S12 is YES, the control device 32 determines that an error has occurred (S14), and proceeds to the first identification process illustrated in FIG. 3. When S12 is NO, the control device 32 proceeds to a S22 process to be described later.

When S10 is NO, the control device 32 determines whether or not the opening degree of the three-way valve 20 is 100 percent (S16). When the opening degree of the three-way valve 20 is 100 percent, the flow diversion ratio to the bypass channel 18 is zero percent. Therefore, the cooling medium in the first cooling medium return channel 14b is returned to the radiator 12 without passing through the bypass channel 18. Then, the cooling medium after passing through the radiator 12 is sent to the second cooling medium outgoing channel 16a without receiving the merging of the cooling medium from the bypass channel 18. In the fuel cell system 100 of the present embodiment, the opening degree of the three-way valve 20 is set to 100 percent when the power generation in the fuel cell stack 102 is continued and the change in the water temperature of the cooling system 10 becomes relatively small.

When S16 is YES, the control device 32 determines whether or not the difference between the detected value S3 by the third temperature sensor 28 and the detected value S2 by the second temperature sensor 26 is equal to or greater than the second predetermined value B (S18). Here, the difference between the detected value S3 by the third temperature sensor 28 and the detected value S2 by the second temperature sensor 26 means the absolute value of the difference between the two detected values S2, S3. As described above, when the opening degree of the three-way valve 20 is 100 percent, the cooling medium after passing through the radiator 12 is sent to the intercooler 114 through the second cooling medium outgoing channel 16a without being mixed with the cooling medium from the bypass channel 18. Therefore, the temperature of the cooling medium after passing through the radiator 12 is approximate to the temperature of the cooling medium before passing through the intercooler 114, and is also approximate to the temperature of the air after passing through the intercooler 114. Here, the temperature of the cooling medium after passing through the radiator 12 is detected by the third temperature sensor 28, and the temperature of the air after passing through the intercooler 114 is detected by the second temperature sensor 26. The second predetermined value B can be determined in consideration of natural heat dissipation that may occur in the cooling medium, measurement errors that may occur in the temperature sensors 26 and 28, and the like. The second predetermined value B may be a constant value, or may be a variation value that is changed according to a specific condition. When S18 is YES, the control device 32 determines that an error has occurred (S20), and proceeds to the second identification process illustrated in FIG. 4. When S18 is NO, the control device 32 proceeds to a S22 process to be described later.

When S18 is NO, the control device 32 determines whether the difference between the detected value S4 from the fourth temperature sensor 30 and the detected value S2 from the second temperature sensor 26 is equal to or greater than the third predetermined value C (S24). Here, the difference between the detected value S4 from the fourth temperature sensor 30 and the detected value S2 from the second temperature sensor 26 means the absolute value of the difference between the two detected values S2, S4. In the cooling system 10 of the present embodiment, regardless of the degree of opening of the three-way valve 20, part of the cooling medium in the first cooling medium outgoing channel 14a is sent to the intercooler 114 via the second cooling medium outgoing channel 16a, and the remainder of the cooling medium in the first cooling medium outgoing channel 14a is sent to the fuel cell stack 102. Therefore, the temperature of the cooling medium before passing through the fuel cell stack 102 approximates the temperature of the cooling medium before passing through the intercooler 114. As described above, the temperature of the cooling medium before passing through the intercooler 114 is approximate to the temperature of the air after passing through the intercooler 114. Based on the above relationship, the temperature of the cooling medium before passing through the fuel cell stack 102 is approximate to the temperature of the air after passing through the intercooler 114, regardless of the opening degree of the three-way valve 20. The temperature of the cooling medium before passing through the fuel cell stack 102 is detected by the fourth temperature sensor 30, and the temperature of the air after passing through the intercooler 114 is detected by the second temperature sensor 26. The third predetermined value C can be determined in consideration of natural heat dissipation that may occur in the cooling medium, measurement errors that may occur in the temperature sensors 26 and 30, and the like. The third predetermined value C may be a constant value, or may be a variation value that is changed according to a specific condition. When S22 is YES, the control device 32 determines that an abnormality is present (S24), and ends the abnormality monitoring process. When S16 is NO, the control device 32 ends the abnormality monitoring process.

Next, the first identification process illustrated in FIG. 3 will be described. The first identification process is performed when YES in S12 of FIG. 2. If S12 determines YES and an abnormality is detected (S14), the abnormal part is considered to be a site associated with the first temperature sensor 24 or a site associated with the second temperature sensor 26. By performing the first identification process, the control device 32 identifies either a part related to the first temperature sensor 24 or a part related to the second temperature sensor 26 as an abnormal part.

The control device 32 first changes the opening degree of the three-way valve 20 to 100 percent (S28). Then, it is determined whether or not the difference between the detected value S3 from the third temperature sensor 28 and the detected value S2 from the second temperature sensor 26 is equal to or greater than the second predetermined value B (S30). For example, when an abnormality occurs in a part related to the first temperature sensor 24, the difference between the detected value S3 from the third temperature sensor 28 and the detected value S2 from the second temperature sensor 26 is less than the second predetermined value B. On the other hand, when an abnormality occurs in a part related to the second temperature sensor 26, the difference between the detected value S3 from the third temperature sensor 28 and the detected value S2 from the second temperature sensor 26 is equal to or greater than the second predetermined value B. Therefore, when YES in S30, the control device 32 identifies a part related to the second temperature sensor 26 as an abnormal part (S32), and ends the abnormality monitoring process. When NO in S30, the control device 32 identifies a part related to the first temperature sensor 24 as an abnormal part (S34), and ends the abnormality monitoring process. S30 process is the same as S18 process described above.

Next, the second identification process illustrated in FIG. 4 will be described. The second identification process is performed when YES in S18 of FIG. 2. The second identification process corresponds to a process in which a combination of the first temperature sensor 24 and the second temperature sensor 26 in the first identification process is changed to a combination of the second temperature sensor 26 and the third temperature sensor 28. That is, the control device 32 performs the second identification process of identifying either a part related to the second temperature sensor 26 or a part related to the third temperature sensor 28 as an abnormal part.

The control device 32 first changes the opening degree of the three-way valve 20 to zero percent (S36). Then, it is determined whether or not the difference between the detected value S1 by the first temperature sensor 24 and the detected value S2 by the second temperature sensor 26 is equal to or greater than the first predetermined value A (S38). When YES in S38, the control device 32 identifies a part related to the second temperature sensor 26 as an abnormal part (S40), and ends the abnormality monitoring process. When NO in S38, the control device 32 identifies a part related to the third temperature sensor 28 as an abnormal part (S42), and ends the abnormality monitoring process. S38 process is the same as S12 process described above.

As described above, in the above-described abnormality monitoring process, the abnormality of the cooling system 10 can be easily detected by comparing the detected values S1, S2, S3, S4 of the two temperature sensors among the plurality of temperature sensors 24, 26, 28, and 30. Note that the processing of S12 in this specification corresponds to the first determination processing in the present technology, the processing of S16 in this specification corresponds to the second determination processing in the present technology, and the processing of S22 in this specification corresponds to the third determination process in the present technology. The three-way valve 20 in the present specification corresponds to a flow regulating valve in the present technology.

In the abnormality monitoring process illustrated in FIG. 2, when YES in S12 and the control device 32 determines that there is an abnormality, the process proceeds to the first identification process illustrated in FIG. 3. In this first identification process, the control device 32 identifies a part related to the second temperature sensor 26 as an abnormal part when YES also in S30 (S32). On the other hand, when NO in S30, the control device 32 identifies a part related to the first temperature sensor 24 as an abnormal part (S34). According to such a configuration, it is possible to identify an abnormal part in the cooling system 10 with a relatively simple configuration.

In the abnormality monitoring process illustrated in FIG. 2, the control device 32 is YES in S18, and when it is determined that an abnormality is present, the process proceeds to the second identification process illustrated in FIG. 4. In the second identification process, when YES in S38, the control device 32 identifies a part related to the second temperature sensor 26 as an abnormal part (S40). On the other hand, when NO in S38, the control device 32 identifies a part related to the third temperature sensor 28 as an abnormal part (S42). According to such a configuration, it is possible to identify an abnormal part in the cooling system 10 with a relatively simple configuration.

As an example, in the abnormality monitoring process illustrated in FIG. 2, at least one of the first identification process and the second identification process may be omitted. That is, in the abnormality monitoring device illustrated in FIG. 2, the control device 32 does not necessarily need to identify an abnormal part.

As an example, in the abnormality monitoring process illustrated in FIG. 2, S18 and the process related thereto may be omitted. That is, in the abnormality monitoring process, the second determination process in the present technology may be omitted.

In addition to or instead of the above, in the abnormality monitoring process illustrated in FIG. 2, S22 and the process related thereto may be omitted. That is, in the abnormality monitoring process, the third determination process in the present technology may be omitted. In this case, the cooling system 10 of the present embodiment does not necessarily have to include the fourth temperature sensor 30, but only has to include three temperature sensors 24, 26, and 28.

In S12 of FIG. 2, the difference between the detected value S1 from the first temperature sensor 24 and the detected value S2 from the second temperature sensor 26 means the absolute value of the difference between the two detected values S1, S2. However, as another embodiment, the difference between the detected value S1 from the first temperature sensor 24 and the detected value S2 from the second temperature sensor 26 may be a difference in the detected value S1 from the first temperature sensor 24 with respect to the detected value S2 from the second temperature sensor 26 (that is, detected value S1−detected value S2, which may take a positive or negative value). Here, in S12 of FIG. 2, it is preferable to determine “detected value S1−detected value S2>desired predetermined value” or “detected value S1−detected value S2≥desired predetermined value”. As a result, only when the detected value S1 is higher than the detected value S2, it can be determined that an error occurs. The same applies to the difference between the detected value S3 from the third temperature sensor 28 and the detected value S2 from the second temperature sensor 26 in S18 of FIG. 2 and the difference between the detected value S4 from the fourth temperature sensor 30 and the detected value S2 from the second temperature sensor 26 in S24.

While several specific examples have been described in detail above, these are merely illustrative and do not limit the scope of the claims. The technique described in the claims includes various modifications and variations of the specific examples exemplified above. The technical elements described in this specification or in the drawings may be used alone or in combination to achieve technical usefulness.

What is claimed is:

1. A cooling system for a fuel cell that cools a fuel cell stack and an intercooler that cools an oxidizing gas to be supplied to the fuel cell stack, the cooling system comprising:
a radiator;
a stack cooling circuit including a first cooling medium outgoing channel that sends a cooling medium from the radiator to the fuel cell stack, and a first cooling medium return channel that returns the cooling medium from the fuel cell stack to the radiator;
an intercooler cooling circuit including a second cooling medium outgoing channel that branches off from the first cooling medium outgoing channel and that sends the cooling medium to the intercooler, and a second cooling medium return channel that merges from the intercooler into the first cooling medium return channel and that returns the cooling medium;
a bypass channel that branches off from the first cooling medium return channel to bypass the radiator and that sends the cooling medium to the first cooling medium outgoing channel;
a flow regulating valve that is located at a branch point where the bypass channel branches off from the first cooling medium return channel and that regulates a flow diversion ratio to the bypass channel;
a first temperature sensor that is located in the first cooling medium return channel and that detects a temperature of the cooling medium after passing through the fuel cell stack;
a second temperature sensor that detects a temperature of the oxidizing gas after passing through the intercooler; and
a control device that performs an abnormality monitoring process of monitoring the cooling system for an abnormality, wherein
the abnormality monitoring process includes a first determination process of determining that there is an abnormality when the flow diversion ratio of the flow regulating valve is 100 percent and a difference between a detected value from the first temperature sensor and a detected value from the second temperature sensor is equal to or greater than a first predetermined value.

2. The cooling system according to claim 1, further comprising a third temperature sensor that is located in the first cooling medium outgoing channel and that detects a temperature of the cooling medium after passing through the radiator, wherein the abnormality monitoring process includes a second determination process of determining that there is an abnormality when the flow diversion ratio of the flow regulating valve is zero percent and a difference between a detected value from the third temperature sensor and the detected value from the second temperature sensor is equal to or greater than a second predetermined value.

3. The cooling system according to claim 2, wherein:
the abnormality monitoring process further includes a first identification process of, when determination is made in the first determination process that there is an abnormality, identifying an abnormal part by changing the flow diversion ratio of the flow regulating valve to zero percent and then performing the second determination process; and
in the first identification process, when determination is also made in the second determination process that there is an abnormality, a part related to the second temperature sensor is identified as the abnormal part, and when determination is made in the second determination process that there is no abnormality, a part related to the first temperature sensor is identified as the abnormal part.

4. The cooling system according to claim 2, wherein:
the abnormality monitoring process further includes a second identification process of, when determination is made in the second determination process that there is an abnormality, identifying an abnormal part by changing the flow diversion ratio of the flow regulating valve to 100 percent and then performing the first determination process; and
in the second identification process, when determination is also made in the first determination process that there is an abnormality, a part related to the second temperature sensor is identified as the abnormal part, and when determination is made in the first determination process that there is no abnormality, a part related to the third temperature sensor is identified as the abnormal part.

5. The cooling system according to claim 1, further comprising a fourth temperature sensor that is located in the first cooling medium outgoing channel and that detects a temperature of the cooling medium before passing through the fuel cell stack, wherein the abnormality monitoring process includes a third determination process of determining that there is an abnormality when a difference between a detected value from the fourth temperature sensor and the detected value from the second temperature sensor is equal to or greater than a third predetermined value regardless of the flow diversion ratio of the flow regulating valve.
